(19) United States
(12) Patent Application Publication
(10) Pub. No.: US 2013/0164097 A1
(43) Pub. Date: Jun. 27, 2013

(54) SECURITY FASTENER

(71) Applicant: QING-YUN CHEN, Shenzhen City (CN)

(72) Inventor: QING-YUN CHEN, Shenzhen City (CN)

(21) Appl. No.: 13/648,439

(22) Filed: Oct. 10, 2012

(30) Foreign Application Priority Data
Dec. 26, 2011 (CN) 201110440923.5

(51) Int. Cl. F16B 23/00

(52) U.S. Cl. 411/405

(57) ABSTRACT

A fastener includes a screw rod and a head connected to the screw rod. The head includes a driving surface furthest from the screw rod. The driving surface defines at least two driving grooves arranged around a circumference of a circle with an axis of the screw rod being the center of the circle. The driving surface forms at least two driving lobes received in each of at least two driving grooves, and the at least two driving lobes are located at the circumference of the circle around the axis of the screw rod.

### BACKGROUND

1. Technical Field

The present disclosure relates to fasteners, particularly to a keyed fastener.

2. Description of Related Art

Fasteners fasten two or more workpieces together. A common fastener includes a screw rod and a head connected to the screw rod. The head usually defines a crisscross driving groove, or a straight slot driving groove, for allowing a suitable tool to be inserted into to fasten or to detach the fastener. However, these fasteners can be detached by many types of tools. Special workpieces, such as high precision workpieces or dangerous workpieces, may need fasteners which can resist disassembly. In addition, the common fastener may be overused during the fastening and detaching, which affects a working life and performance of the fastener.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of an embodiment of a fastener.

FIG. 2 is a top view of the fastener shown in FIG. 1.

FIG. 3 is a sectional view of the fastener shown in FIG. 1.

FIG. 4 is a cut-away view of the fastener shown in FIG. 1.

FIG. 5 is a driving force analysis view of the fastener of FIG. 1 when fastening and detaching.

FIG. 6 is a torsion force analysis schematic view of the fastener of FIG. 1 when fastening.

### DETAILED DESCRIPTION

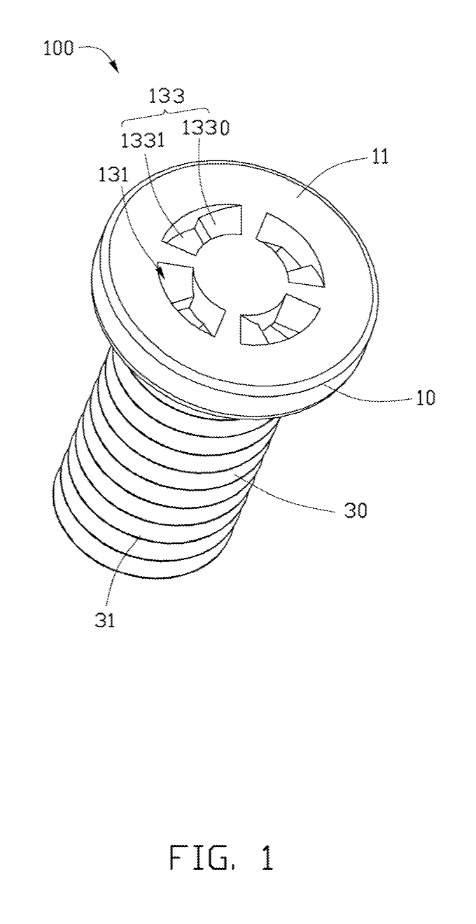

FIG. 1 shows an embodiment of a fastener 100. The fastener 100 includes a head 10 and a screw rod 30 coaxially protruding from the head 10. The head 10 is substantially cylindrical, and includes a driving surface 11 at an end furthest from the screw rod 30. The screw rod 30 is substantially a cylindrical rod, and has a plurality of threads 31 at a sidewall thereof.

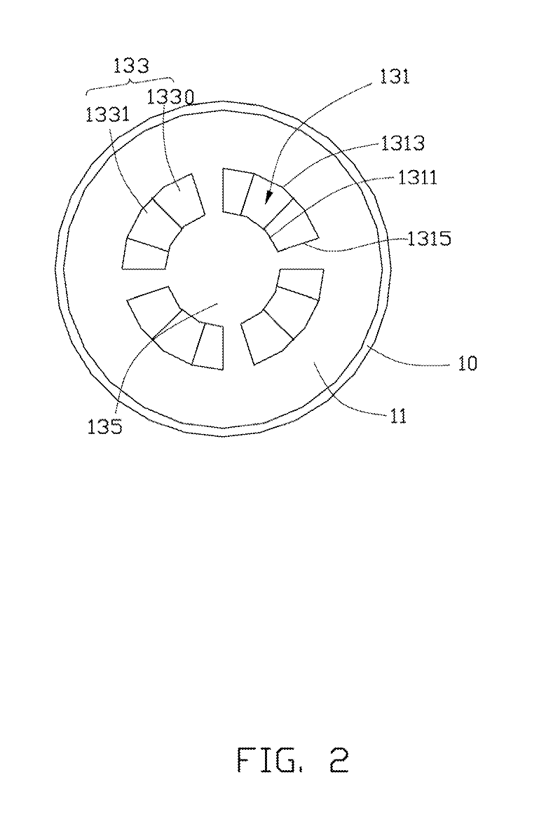

FIG. 2 shows the driving surface 11 defining four fan-shaped driving grooves 131. The four driving grooves 131 are equidistantly arranged around an axis of the screw rod 30. A driving lobe 133 is formed in each of the driving grooves 131. A center column 135 is defined by the four driving grooves 131 at a center of the driving surface 11, for positioning a tool (not shown) when disassembling the fastener 100. The center column 135 is also coaxial with the head 10.

Each driving groove 131 defines an inner arcuate sidewall 1311, an outer arcuate sidewall 1313, and a pair of connecting sidewalls 1315. The outer arcuate sidewall 1313 is opposite to the inner arcuate sidewall 1311, and is positioned at a side of the inner arcuate sidewall 1311 away from the center column 135. Each of the connecting sidewalls 1315 interconnects opposite ends of the inner arcuate sidewall 1311 and the outer arcuate sidewall 1313. The inner arcuate sidewall 1311, the outer arcuate sidewall 1313, and the connecting sidewalls 1315 cooperatively define the driving groove 131. The radius of the circle described by the connecting sidewalls 1315 passes through the axis of the head 10.

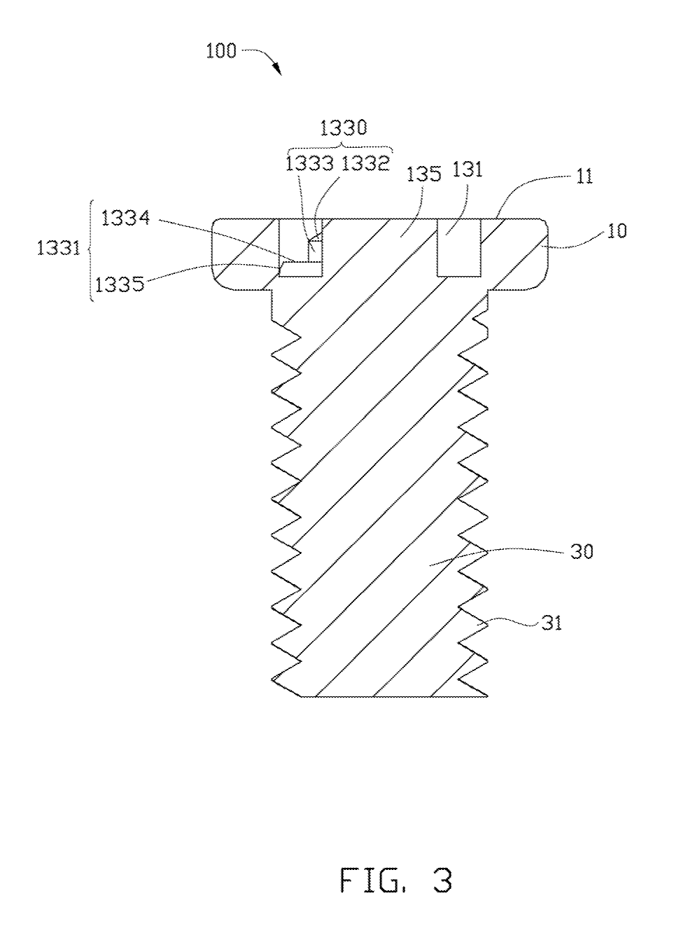

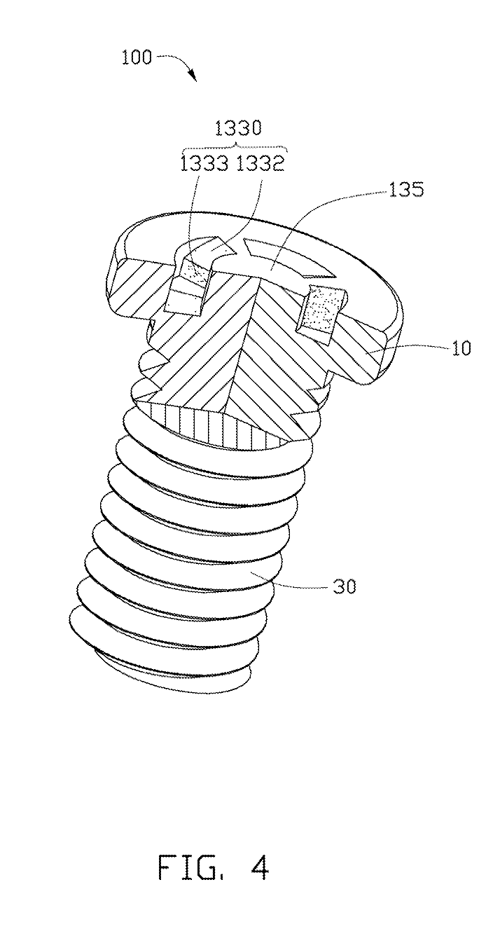

FIGS. 3 and 4 show the driving lobes 133. Each driving lobe 133 is substantially spiral, and a top surface (not labeled) thereof is substantially a stepped surface. The top surface extends from the driving surface 11 downward to connect with a bottom of the driving groove 131, for allowing a driving tool (not shown) to be conveniently inserted and pulled out from the driving groove 131.

In the illustrated embodiment, each of the driving lobes 133 includes a first lobe portion 1330 and a second lobe portion 1331 connecting with the first lobe portion 1330, such that the sideways profile of the driving lobe 133 has three steps. The first lobe portion 1330 includes a first spiral surface 1332 and a resisting surface 1333. The first spiral surface 1332 extends from the driving surface 11 downward to connect with the resisting surface 1333. The resisting surface 1333 is perpendicular to the driving surface 11, and an inwards extension of the resisting surface 1333 passes through the axis of the head 10. The resisting surface 1333 extends downward further to connect with the second lobe portions 1331.

The second lobe portion 1331 includes a second spiral surface 1334, and a third spiral surface 1335. The second spiral surface 1334 extends from the resisting surface 1333 downward to connect with the third spiral surface 1335. The third spiral surface 1335 extends from the second spiral surface 1334 to connect with the bottom of the driving groove 131. The first spiral surface 1332, the second spiral surface 1334, and the third spiral surface 1335 are all substantially spiral, and are designed to follow an Archimedean screw. A spiral center axis of the driving lobe 133 overlaps with the axis of the head 10. A downward spiral direction of the driving lobe 133 is opposite to a downward spiral direction of the threads 31.

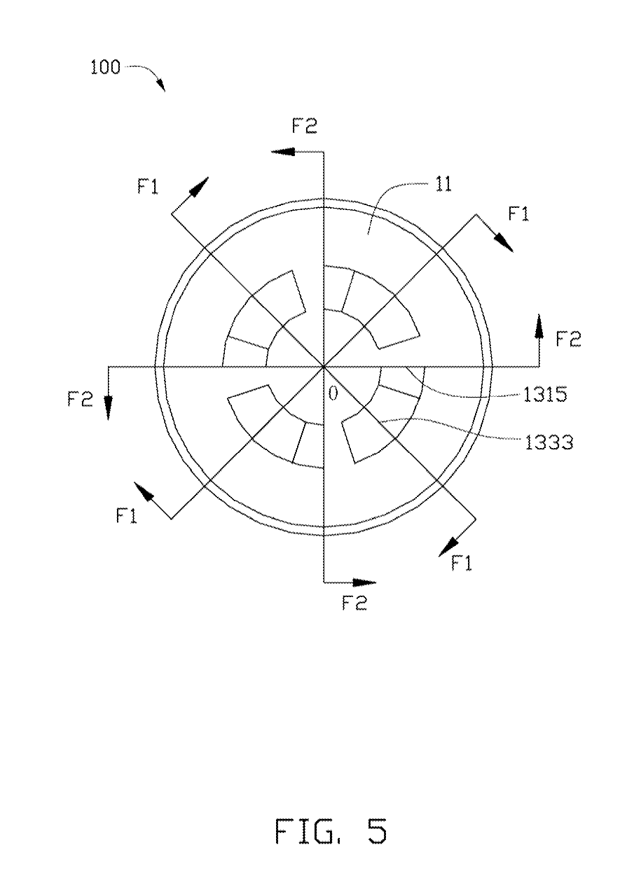

FIG. 5 shows a driving force analysis of the fastener 100 when fastening and detaching it. When fastening, a driving tool (not shown) having a profile corresponding to the driving lobes 133 is inserted to the driving grooves 131 and resists with the resisting sidewalls 1333, for driving the fastener 100 to rotate in a clockwise direction seen from above the head 10. When detaching, the driven tool resists with the connecting sidewalls 1315 away from the first lobe portions 1330, for driving the fastener 100 to rotate in the opposite direction. Because the inner extension of the resisting surfaces 1333 and the radial extension described by the connecting sidewalls 1315 both pass through the axis of the head 10, a driving force F1 applied to the resisting surface 1333 by the driving tool and a driving force F2 applied to the connecting sidewall 1315 by the driving tool are parallel to tangent lines of the circular head 10. Therefore, a driving angle between the driving force F1 or F2 and a corresponding rotation direction equals zero degrees when rotating the fastener 100, and the driving angle does not change even if the point(s) of contact of the driving tool is changed.

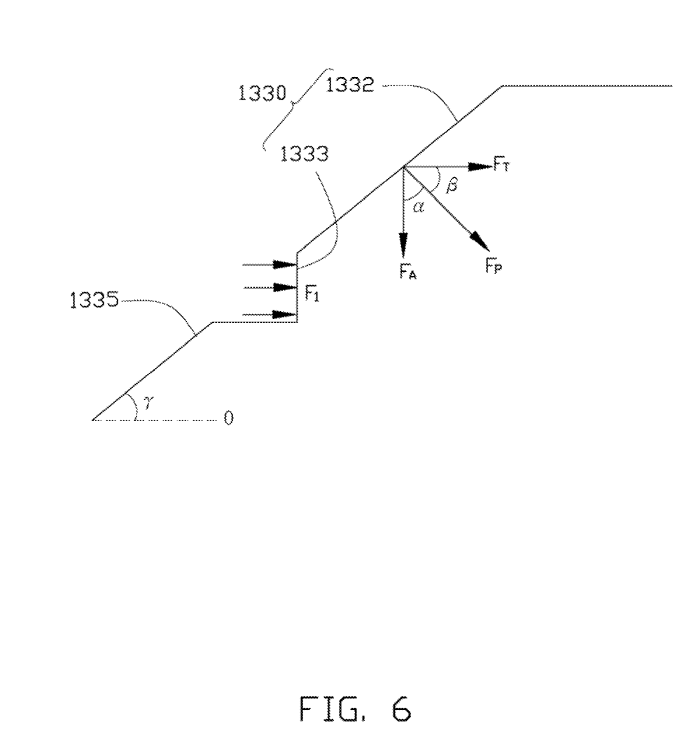

FIG. 6 shows a stretched, schematic view of the driving lobe 133, showing a torsion force to the driving lobe 133 when fastening the fastener 100. An included angle between the third spiral surface 1332 and the driving surface 11 is defined as γ. When the fastener 100 is rotated, a torsion force is applied to the driving lobe 133. A part of the torsion force is applied by the driving force F1 to the resisting surface 1333, and another part of the torsion force is applied as a pressure force Fp on the first spiral surface 1332. The resolution of the pressure force Fp is shown in FIG. 6. The pressure force F_{P} is resolved into a split torsion force F_{T} and a split axis force F_{A}. The torsion force F_{T} is parallel to the driving force F₁, and the split axis force F_{A} is always parallel to the axis of the fastener 100. An included angle between the original force F_{P} and the split torsion force F_{T} is defined as β. An included angle between the original force F_{P} and the split axis force F_{A} is defined as α. The mathematical relationship of the functions can be concluded as shown in equations 5, 6, and 7 below:

F_{P}=cos β*F₁, [5]

F_{A}=cos α*F_{P}=cos γ*F_{P}, [6]

F_{T}=sin α*F_{P}. [7].

The split axis force FA is directly proportional relative to arccos α. Because (arccos α+arccos β)=π/2, thus sin α is inversely proportional relative to arccos α. When arccos α approaches zero, force F_{A} approaches force F_{P}, and sin α approaches zero, which results in the pressure force F_{P} on the first spiral surface 1332 being almost equal to zero, and the axis split F_{A} does not exist. In the illustrated embodiment, an optimizing value of the arccos α ranges from π/6 to π/3, an optimizing value of the arccos β ranges from π/6 to π/3, and the degree of a equals the degree of γ.

In other embodiments, the four driving grooves 131 can be located at two circles of different diameters on the driving surface 11 relative to the center column 135. That is, two symmetrically arranged driving grooves 131 relative to the center column 135 are located at a circumference of a circle, and another two symmetrically arranged driving grooves 131 relative to the center column 135 are located at a circumference of another circle.

In other embodiments, the number of the driving grooves 131 can be two, or three, or more than four depending on a size of the head 10, and the number of the driving lobes 131 changes according to the number of the driving grooves 131.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A fastener, comprising:
a screw rod; and
a head connected to the screw rod,
wherein the head comprises a driving surface away from the screw rod, the driving surface defines at least two driving grooves arranged apart around an axis of the screw rod, the driving surface forms at least two driving lobes, each driving lobe is received in each of the at least two driving grooves, and the at least two driving lobes are located around the axis of the screw rod.

2. The fastener of claim 1, wherein the head is cylindrical, and the screw rod is coaxial and perpendicular to the head.

3. The fastener of claim 1, wherein each driving groove is a fan-shaped groove, each driving lobe is spiral, and a top surface of the driving lobe is stepped.

4. The fastener of claim 3, wherein the top surface extends from the driving surface downward to connect with a bottom of the driving groove.

5. The fastener of claim 3, wherein each driving lobe comprises a first lobe portion, the first lobe portion comprises a first spiral surface and a resisting surface, the first spiral surface extends from the driving surface downward to connect with the resisting surface, the resisting surface is perpendicular to the driving surface, and an inward extension of the resisting surface passes through the axis of the screw rod.

6. The fastener of claim 5, wherein each driving lobe further comprises a second lobe portion received in a corresponding driving groove, the second lobe portion comprises a second spiral surface and a third spiral surface, the second spiral surface extends from the resisting surface downward to connect with the third spiral surface, the third spiral surface extends from the second spiral surface downward to connect with the bottom of the driving groove.

7. The fastener of claim 6, wherein the first spiral surface, the second spiral surface, and the third spiral surface are designed according to Archimedean screw rule, and a center axis of the driving lobe overlaps with the axis of the screw rod.

8. The data transmission system of claim 7, wherein the screw rod comprises a plurality of threads, and a downward spiral direction of each driving lobe is opposite to a downward spiral direction of the threads.

9. The fastener of claim 5, wherein each driving groove defines an inner arcuate sidewall, an outer arcuate sidewall, and a pair of connecting sidewalls, the connecting sidewalls interconnect opposite ends of the inner arcuate sidewall and the outer arcuate sidewall, and the radius of the circle described by the connecting sidewalls passes through the axis of the screw rod.

10. The fastener of claim 1, wherein a center column is defined by the at least two driving grooves at a center of the driving surface, and the center column is coaxial with the screw rod, for positioning a tool when disassembling the fastener.

11. A fastener, comprising:
a screw rod; and
a head connected to the screw rod,
wherein the head comprises a driving surface away from the screw rod, the driving surface defines four driving grooves arranged apart, two of the four driving grooves symmetrically arranged at a circumference of a circle around an axis of the screw , and another two of the four driving grooves symmetrically arranged at a circumference of another circle around the axis of the screw rod , the driving surface forms four driving lobes, each driving lobe is received in each of the driving grooves, and the driving lobes are located around the axis of the screw rod.

12. The fastener of claim 11, wherein each driving groove is a fan-shaped groove, each driving lobe is spiral, and a top surface of the driving lobe is stepped.

13. The fastener of claim 12, wherein the top surface extends from the driving surface downward to connect with a bottom of the driving groove.

14. The fastener of claim 12, wherein each driving lobe comprises a first lobe portion, the first lobe portion comprises a first spiral surface and a resisting surface, the first spiral surface extends from the driving surface downward to connect with the resisting surface, the resisting surface is perpendicular to the driving surface, and an inward extension of the resisting surface passes through the axis of the screw rod.

15. The fastener of claim 14, wherein each driving lobe further comprises a second lobe portion received in a corresponding driving groove, the second lobe portion comprises a second spiral surface and a third spiral surface, the second spiral surface extends from the resisting surface downward to connect with the third spiral surface, the third spiral surface extends from the second spiral surface downward to connect with the bottom of the driving groove.

16. The fastener of claim 15, wherein the first spiral surface, the second spiral surface, and the third spiral surface are designed according to Archimedean screw rule, and a center axis of the driving lobe overlaps with the axis of the screw rod.

17. The data transmission system of claim 16, wherein the screw rod comprises a plurality of threads, and a downward spiral direction of each driving lobe is opposite to a downward spiral direction of the threads.

18. The fastener of claim 14, wherein each driving groove defines an inner arcuate sidewall, an outer arcuate sidewall, and a pair of connecting sidewalls, the connecting sidewalls interconnect opposite ends of the inner arcuate sidewall and the outer arcuate sidewall, and the radius of the circle described by the connecting sidewalls passes through the axis of the screw rod.
